(19) United States
(12) Patent Application Publication
(10) Pub. No.: US 2013/0301275 A1
(43) Pub. Date: Nov. 14, 2013

(54) LED LIGHT WITH MULTIPLE HEAT SINKS

(71) Applicant: LED FOLIO CORPORATION, Beverly Hills, CA (US)

(72) Inventor: Steven KIM, Beverly Hills, CA (US)

(73) Assignee: LED FOLIO CORPORATION, Beverly Hills, CA (US)

(21) Appl. No.: 13/893,732

(22) Filed: May 14, 2013

Related U.S. Application Data
(60) Provisional application No. 61/646,583, filed on May 14, 2012.

(51) Int. Cl. F21V 29/00

(52) U.S. Cl. CPC F21V 29/22
USPC 362/294

(57) ABSTRACT

A light emitting diode bulb includes: a socket base configured for insertion into a light fixture; a plurality of separate heat sinks attached to the socket base; light emitting diode elements mounted on the plurality of separate heat sinks; and an optical element covering one of the light emitting diode elements.

This invention claims the benefit of U.S. Provisional Patent Application No. 61/646,583 filed on May 14, 2012, which is hereby incorporated by reference in its entirety.

### BACKGROUND OF THE INVENTION

1. Field of the Invention

Embodiments of the invention relate to the structure of an LED (light-emitting diode) bulb. More particularly, they relate to the structure of a heat sink within an LED bulb. Although the embodiments of the invention are suitable for a wide scope of applications, it is particularly suitable for more effective heat dissipation and heat isolation in multi-LED element light bulbs.

2. Discussion of the Related Art

In general, an LED light bulb includes one or more LED elements. An LED element produces illumination by turning a given amount of electric power into a certain amount of light. Electric power is typically measured in watts and the amount of light illumination is measured in lumens. An LED element converts electric power into light more efficiently than standard incandescent filament. LED bulbs are bright enough to replace incandescents. More specifically, an LED bulb producing the same number of lumens as a standard 60-watt incandescent bulb is only using twelve watts of power. In other words, a 60-watt incandescent bulb produces about 800 lumens of light just like a 12-watt LED bulb.

Unlike an incandescent bulb that typically uses only a single light source, which is a filament, an LED bulb typically has a collection of a plurality of light sources in that each light source is an LED element. Thus, the collection of LED elements cumulatively produces the light emanating from a LED bulb. For example, a 12-watt LED bulb can be a collection of four 3-watt LED elements, three 4-watt LED elements or six 2-watt elements to produce 800 lumens of light. Each of the LED elements can include one or more LED chips.

Although LED bulbs are much more efficient in converting electric power into light than incandescent bulbs, the LED elements still create heat. Further, an LED element can overheat so as to quit working, have severely shortened lifespan or incur damage that reduces power-to-light conversion efficiency. Higher wattage LED elements tend to be more efficient in converting electric power to light but also tend to be more susceptible to overheating. Thus, heat sink requirements for an individual LED element increases as the wattage capability for an LED element increases.

FIG. 1 is a perspective view of a prior art LED bulb with multiple LED elements on a heat sink under a single dispersion lens. As shown in FIG. 1, an LED bulb 100 includes a socket base 101. One end of the socket base 101 has a screw cap 102 for insertion into a light fixture. The other end of the socket base 101 opposite to the screw cap 102 has a base plate 103. AC-to-DC conversion circuitry is housed within the socket base 101 between the screw cap 102 and the base plate 103.

The LED bulb 100 shown in FIG. 1 also includes a heat sink 113 attached to the base plate 103. The heat sink 113 can be attached by screws (not shown) that go through the screw holes 104 in the base plate 103 and screw into the heat sink 113 to fasten the heat sink 113 to the base plate 103. The heat sink 113 can be metallic, such as Al or Cu. In the alternative, the heat sink 113 can be heat conductive ceramic, such as alumina.

The LED bulb 100 shown in FIG. 1 further includes LED elements 120a-120d mounted on the heat sink 113. The wiring (not shown) for the LED elements 120a-120d passes through the heat sink 113 and through wiring holes 104 of the base plate 103 into the socket base 101. The LED elements 120a-120d can each be an LED module with one or more LED chips within the LED module. In the case of LED modules as the LED elements 120a-120d, the modules can be permanently attached to the heat sink 113 by soldering (not shown) or removably attached to the heat sink 113 with screws (not shown).

The LED bulb 100 shown in FIG. 1 has a lens 130 overlying the LED elements 120a-120d on the heat sink 113. The lens 130 can be a dispersion lens that disperses light from the LED elements 120a-120d. In the alternative, the lens 130 can be a conversion lens that focuses light from the LED elements 120a-120d. Both the dispersion lens and the conversion lens can include materials for light diffusion and/or have structural features for light refraction/diffusion purposes. The lens 130 can be made of a glass material, a polymer material or layers of such materials.

The prior art LED bulb, as shown in FIG. 1, generally has at least four portions. The first portion is a socket part containing AC-to-DC conversion circuitry that is configured to screw into a light fixture. The second portion is a heat sink part attached to the socket part. The third portion is the LED elements, which can be LED modules, mounted on the heat sink part. The fourth portion is an optical element part above the LED elements to disperse or, alternatively, focus light from the LED elements. The LED elements is the portion that typically has a failure in the prior art LED bulb.

A single LED element, such as an LED module, of a prior art LED bulb can fail. Further, a failing LED element of a prior art LED bulb tends to overheat and accelerate the failure of other LED elements on the heat sink. Replacing a single LED module in an LED bulb is more cost effective than replacing the entire LED bulb. An LED module can be replaced in a prior art LED bulb by removing the optical element and replacing a module that is removably attached to the heat sink 113. However, a removably attached LED module has less thermal conductivity to the heat sink 113 than an LED module permanently attached to the heat sink.

### SUMMARY OF THE INVENTION

Accordingly, embodiments of the invention is directed to a solid state power source with frames for attachment to an electronic circuit that substantially obviates one or more of the problems due to limitations and disadvantages of the related art.

An object of embodiments of the invention is to provide an LED bulb with a modular heat sink structure.

Another object of embodiments of the invention is to provide improved heat dissipation for LED elements in an LED light bulb.

Another object of embodiments of the invention is to provide thermal isolation between LED elements in an LED light bulb.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a light emitting diode bulb includes: a socket base configured for insertion into a light fixture; a plurality of separate heat sinks attached to the socket base; light emitting diode elements mounted on the plurality of separate heat sinks; and an optical element covering one of the light emitting diode elements.

In another aspect, the light emitting diode bulb includes: a socket base configured for insertion into a light fixture; a plurality of spaced-apart heat sinks on the socket base; light emitting diode elements mounted on the plurality of spaced-apart heat sinks; and lenses respectively mounted on the plurality of spaced-apart heat sinks.

In yet another aspect, the light emitting diode bulb includes: a socket base configured for insertion into a light fixture; a plurality of spaced-apart heat sinks on the socket base; light emitting diode elements mounted on the plurality of spaced-apart heat sinks; optical elements respectively mounted on the plurality of spaced-apart heat sinks to cover the light emitting diode elements; and a retention plate positioned across each of the plurality of spaced-apart heat sinks.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a perspective view of a prior art LED bulb with multiple LED elements on a heat sink under a single dispersion lens.

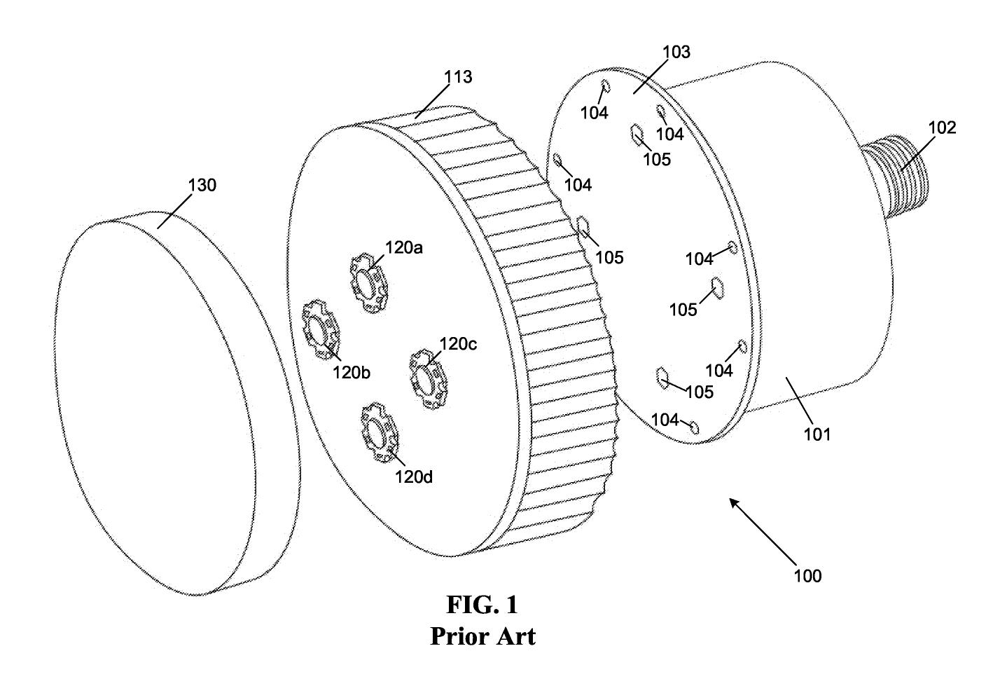

FIG. 2 is a perspective view of an LED bulb with multiple LED elements that are each on an individual heat sink according to an embodiment of the invention.

FIG. 3 is a front view of multiple LED elements that are each on an individual heat sink according to an embodiment of the invention.

FIG. 4 is a perspective view of multiple LED elements that are each on an individual heat sink according to an embodiment of the invention.

FIG. 5 is a perspective view of an LED bulb with multiple LED elements that are each on an individual heat sink and are each covered by a respective dispersion lens according to an embodiment of the invention.

### DETAILED DESCRIPTION OF THE PREFERRED EMBODIMENTS

Reference will now be made in detail to preferred embodiments of the invention, examples of which are illustrated in the accompanying drawings. Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

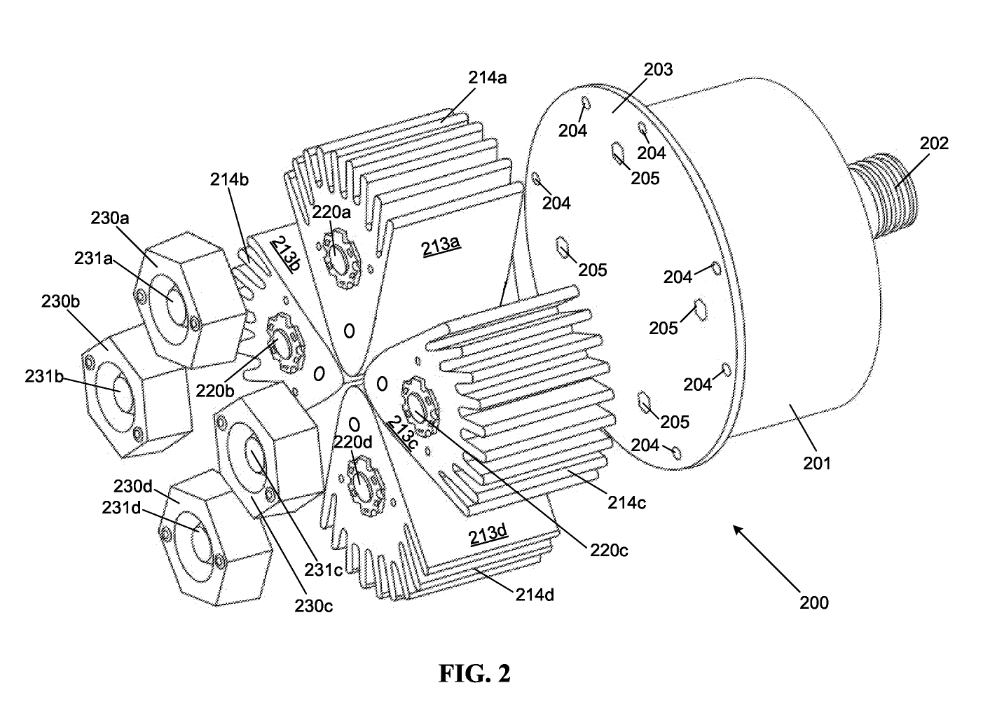

FIG. 2 is a perspective view of an LED bulb with multiple LED elements that are each on an individual heat sink according to an embodiment of the invention. As shown in FIG. 2, an LED bulb 200 according an embodiment of the invention includes a socket base 201. One end of the socket base 201 has a screw cap 202 for insertion into a light fixture. Although the exemplary embodiment shown in FIG. 2 illustrates a screw cap 202, other plug types for light fixtures can be alternatively implemented for insertion into a light fixture on the base 201. The other end of the socket base 201 opposite to the screw cap 202 has a base plate 203.

The LED bulb 200 shown in FIG. 2 also includes separate heat sinks 213a-213d attached to the base plate 203. The separate heat sinks 213a-213d can be respectively attached to the base plate 203 by screws (not shown) that go through the screw holes 204 in the base plate 203 and screw into the separate heat sinks 213a-213d to fasten each of the separate heat sinks 213a-213d, respectively, to the base plate 203. The separate heat sinks 213a-213d can be metallic, such as Al or Cu. In the alternative, the separate heat sinks 213a-213d can be heat conductive ceramic, such as alumina. As shown in FIG. 2, each of the separate heat sinks 213a-213d can have fins 213a-213d for increasing the transmittance of heat from the respective separate heat sink into the air surrounding the LED bulb 200. As shown in FIG. 2, each of the separate heat sinks 213a-213d generally has a triangular shape such that they can all be combined into a circular configuration. In the alternative, each of the separate heat sinks 213a-213d can generally have a rectangular shape such that they can all be combined into a larger rectangular-shaped configuration.

The LED bulb 200 shown in FIG. 2 further includes LED elements 220a-220d mounted on the separate heat sinks 213a-213d, respectively. The wiring (not shown) for the LED elements 220a-220d passes through the separate heat sinks 213a-213d, respectively, and through wiring holes 204 of the base plate 203 into the socket base 201. In the case of LED modules as the LED elements 220a-220d, the modules can be permanently attached to the separate heat sinks 213a-213d, respectively, by a thermal conductive adhesive, such as solder (not shown). In the alternative, the modules can be replaceably attached to the separate heat sinks 213a-213d, respectively, by fasteners, such as screws (not shown).

The LED bulb 200 shown in FIG. 2 has lens mounts 230a-230d with lens 231a-231d overlying the LED elements 220a-220d on the separate heat sinks 213a-213d, respectively. Each of the lens 231a-231d can be a dispersion lens that disperses light from the LED elements 220a-220d. In the alternative, the lens 231a-231d can be a conversion lens that focuses light from the LED elements 220a-220d. Both the dispersion lens and the conversion lens can include materials for light diffusion and/or have structural features for light refraction/diffusion purposes. The lens 231a-231d can be made of a glass material, a polymer material or layers of such materials. The lens mounts 230a-230d can be metallic, such as Al or Cu. A metallic lens mount can act as another heat sink for the LED element. In the alternative, the lens mounts 230a-230d can be a polymer.

Embodiments of the invention include the LED elements 220a-220d shown in FIG. 2 being energized simultaneously or, alternatively, having stages of lighting brightness. For example, the LED bulb 200 can be three-way bulb in that LED element 220a comes on in a first stage, LED elements 220b and 220c come on in a second stage and LED elements 220a-220d come on in a third stage. In another example, the LED bulb 200 can be three-color bulb in that LED elements 220a and 220d comes on in a first stage as red light, LED elements 220b and 220c come on in a second stage as green light and LED elements 220a-220d come on in a third stage to make yellow light.

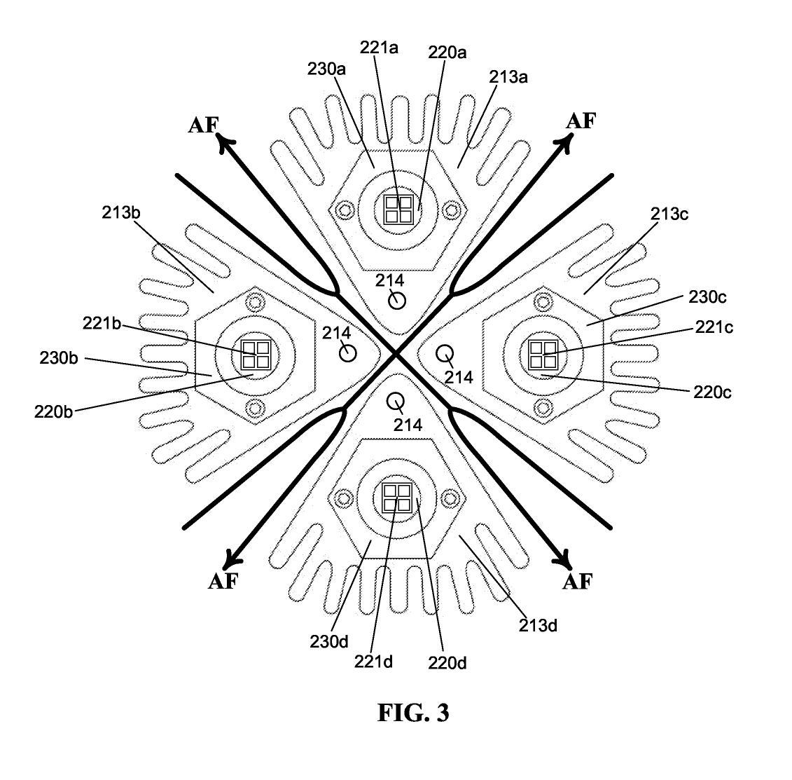

FIG. 3 is a front view of multiple LED elements that are each on an individual heat sink according to an embodiment of the invention. As shown in FIG. 3, the separate heat sinks 213a-213d are space-apart from one another. By spacing the separate heat sinks 213a-213d apart from one another, air AF can flow between and through the spaced-apart heat sinks 213a-213d. The air AF flowing or moving between or through the spaced-apart heat sinks 213a-213d increases the transmission of heat from the spaced-apart heat sinks 213a-213d into the air. In addition, the spacing between the spaced-apart heat sinks 213a-213d isolates the spaced-apart heat sinks 213a-213d from one another. That is, heat from one of the spaced-apart heat sinks 213a-213d is not transferred directly to the other spaced-apart heat sinks 213a-213d. The holes 214 in each of the spaced-apart heat sinks 213a-213d are screw holes.

As shown in FIG. 3, one or more LED chips 221a-221d can be on the LED elements 220a-220d within the lens mounts 230a-230d. Although FIG. 3 shows four LED chips on each of the LED elements 220a-220d, each of the LED elements 220a-220d can alternatively contain just two LED chips, three LED chips or any number of LED chips in an array. In another alternative, the LED elements 220a-220d can have a different number of LED chips. Usually each of LED elements 220a-220d has the same amount of light output but the LED elements 220a-220d can be configured such that the LED elements 220a-220d each emit different amounts of light buy using different light elements.

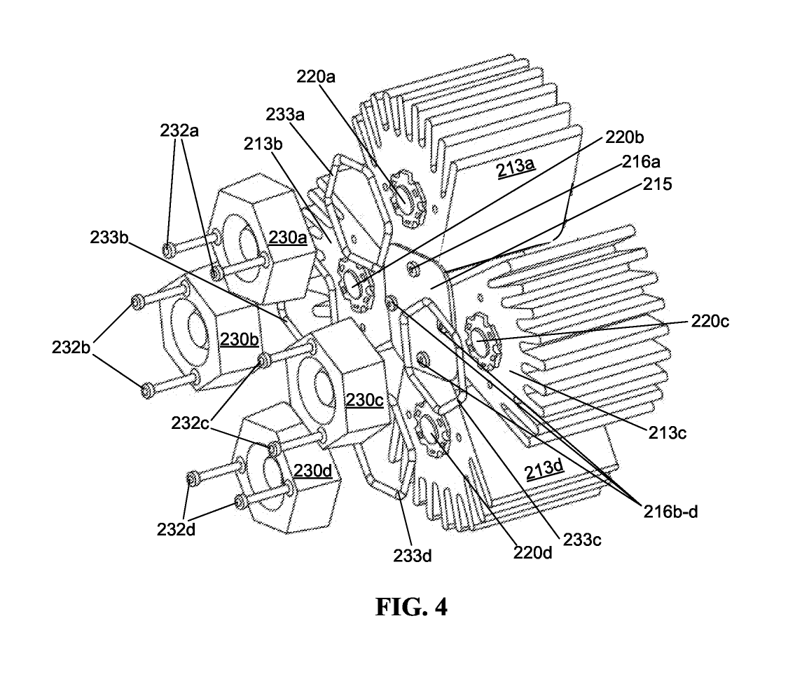

FIG. 4 is a perspective view of multiple LED elements that are each on an individual heat sink according to an embodiment of the invention. As shown in FIG. 4, the lens mounts 230a-230d are fastened onto the spaced-apart heat sinks 213a-213d with screw sets 232a-232d, respectively. Gaskets 233a-233d can be provided between the lens mounts 230a-230d and the spaced-apart heat sinks 213a-213d, respectively. The gaskets 233a-233d provide weatherproof seals between the lens mounts 230a-230d and the spaced-apart heat sinks 213a-213d, respectively. By removing one of the screw sets 232a-232d for one of the lens mounts 230a-230d, that one of the LED elements 220a-220d can be replaced to affect a repair.

A retention plate 215 is shown in FIG. 4 positioned across each of the spaced-apart heat sinks 213a-213d. The screws 216a-216d attach the retention plate 215 onto the spaced-apart heat sinks 213a-213d through the screw holes 214 shown in FIG. 3. The retention plate 215 maintains the spacing relationship of the spaced-apart heat sinks 213a-213d.

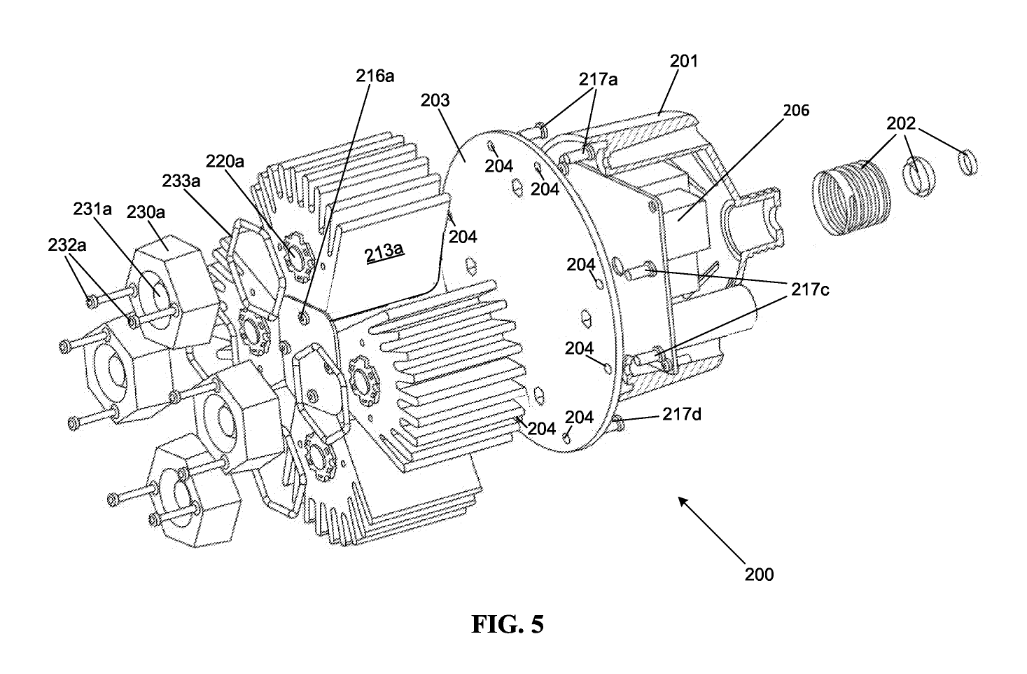

FIG. 5 is a perspective view of an LED bulb with multiple LED elements that are each on an individual heat sink and are each covered by a respective dispersion lens according to an embodiment of the invention. As shown in FIG. 5, AC-to-DC conversion circuitry 206 is housed within the socket base 201 between the screw cap 202 and the base plate 203. The spaced-apart heat sink 213a is mounted on the base plate 203 by screw set 217a through holes 204 in the base plate 203. An LED element 220a is mounted on the spaced-apart heat sink 213a. A lens mounts 230a with a lens 231a is fastened onto the spaced-apart heat sink 213a with screw set 232a. The spaced-apart heat sink 213a is attached to the retention plate 215 with the screw 216a.

In embodiments of the invention, the LED bulb 200 can have an LED element repaired by replacement of the LED element together with the heat sink on which the LED element is positioned along with the lens mounts having a lens overlying the LED element. For example, the LED element 220a mounted on the spaced-apart heat sink 213a along with the lens mounts 230a having a lens 231a can be repaired by replacement. Such a repair includes removing the screw set 217a and screw 216a, and then removing the spaced-apart heat sink 213a with the LED element 220a. Subsequently, another spaced-apart heat sink with an LED element can be positioned on the base plate 203 but below the retention plate 215, and then the screw set 217a and screw 216a are reinstalled.

Replacing LED elements in a LED bulb by replacing both the LED element and the heat sink upon which the LED element is positioned not only enables repair by replacement of failing portions of the bulb but also isolates overheating LED elements from other LED elements of the LED bulb. The spaced-apart heat sinks enable air flow that increase the cooling capability of the spaced-apart heat sinks. The LED elements can be attached to a spaced-apart heat sink so as to maximize heat transference from the LED elements to the spaced-apart heat sink.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode bulb, comprising:
a socket base configured for insertion into a light fixture;
a plurality of separate heat sinks attached to the socket base;
light emitting diode elements mounted on the plurality of separate heat sinks; and
an optical element covering one of the light emitting diode elements.

2. The light emitting diode bulb of claim 1, wherein the plurality of separate heat sinks are spaced apart.

3. The light emitting diode bulb of claim 1, further comprising other optical elements positioned over other ones of the light emitting diode elements.

4. The light emitting diode bulb of claim 1, wherein more than one light emitting diode chip is in a light emitting element.

5. The light emitting diode bulb of claim 1, further comprising an AC-to-DC converter within the socket base.

6. The light emitting diode bulb of claim 1, further comprising a retention plate position across each the plurality of separate heat sinks.

7. The light emitting diode bulb of claim 1, wherein the optical element is a dispersion lens.

8. The light emitting diode bulb of claim 1, wherein the socket base is configured to screw into a light fixture.

9. A light emitting diode bulb, comprising:
a socket base configured for insertion into a light fixture;
a plurality of spaced-apart heat sinks on the socket base;
light emitting diode elements mounted on the plurality of spaced-apart heat sinks; and
lenses respectively mounted on the plurality of spaced-apart heat sinks.

10. The light emitting diode bulb of claim 9, wherein the lenses are respectively attached onto the spaced-apart heat sinks.

11. The light emitting diode bulb of claim 9, wherein more than one light emitting diode chip is in a light emitting element.

12. The light emitting diode bulb of claim 9, further comprising an AC-to-DC converter within the socket base.

13. The light emitting diode bulb of claim 9, further comprising a retention plate positioned across each the plurality of spaced-apart heat sinks.

14. The light emitting diode bulb of claim 9, wherein the lenses are dispersion lenses.

15. The light emitting diode bulb of claim 9, wherein the socket base is configured to screw into a light fixture.

16. A light emitting diode bulb, comprising:
a socket base configured for insertion into a light fixture;
a plurality of spaced-apart heat sinks on the socket base;
light emitting diode elements mounted on the plurality of spaced-apart heat sinks;
optical elements respectively mounted on the plurality of spaced-apart heat sinks to cover the light emitting diode elements; and
a retention plate positioned across each of the plurality of spaced-apart heat sinks.

17. The light emitting diode bulb of claim 16, wherein more than one light emitting diode chip is in a light emitting element.

18. The light emitting diode bulb of claim 16, further comprising an AC-to-DC converter within the socket base.

19. The light emitting diode bulb of claim 16, wherein the optical elements are dispersion lenses.

20. The light emitting diode bulb of claim 16, wherein the socket base is configured to screw into a light fixture.
